(19) United States
(12) Patent Application Publication
(10) Pub. No.: US 2026/0001331 A1
(43) Pub. Date: Jan. 1, 2026

(54) LIQUID EJECTION HEAD

(71) Applicant: CANON KABUSHIKI KAISHA, Tokyo (JP)

(72) Inventors: HIROAKI MIHARA, Tokyo (JP); TOMOHIRO TAKAHASHI, Kanagawa (JP)

(21) Appl. No.: 19/247,361

(22) Filed: Jun. 24, 2025

(30) Foreign Application Priority Data
Jun. 28, 2024 (JP) 2024-104684

(51) Int. Cl. B41J 2/16; B41J 2/14

(52) U.S. Cl. CPC B41J 2/1623; B41J 2/14024; B41J 2/14072; B41J 2002/14362; B41J 2002/14491

(57) ABSTRACT

A liquid ejection head includes an ejection substrate including an ejection port row in a first surface, the ejection port row having a plurality of ejection ports configured to eject liquid arranged in the ejection port row, and a protective member configured to be bonded to the first surface of the ejection substrate via an adhesive, the protective member including a first opening corresponding to the ejection port row. The protective member further includes a second opening between the first opening and an outer edge of the protective member and outside a region where the ejection ports are formed, when viewed from a direction perpendicular to the first surface.

### BACKGROUND

### Field of the Disclosure

The present disclosure relates to a liquid ejection head.

### Description of the Related Art

There is known a line-type liquid ejection apparatus which performs high-speed recording using a liquid ejection head corresponding to the width of a recording medium, the liquid ejection head having a plurality of recording device substrates arranged therein. When continuous recording is performed in one pass while a plurality of recording medium sheets is being continuously or intermittently conveyed, a recording medium sheet being conveyed may float and come into contact with some recording device substrates, causing physical damage to the liquid ejection head. Japanese Patent Application Laid-Open No. 2006-334910 discloses a configuration in which a protective member made of resin or metal is bonded to an ejection surface where ejection ports are formed.

However, in a configuration in which the protective member is bonded to the ejection surface with an adhesive as in Japanese Patent Application Laid-Open No. 2006-334910, air bubbles may be trapped in the adhesive. There is a concern that an air bubble trapped inside the adhesive may expand when the adhesive is heated and cured, and burst near the ejection port, causing the scattered adhesive to adhere to the edge of the ejection port.

### SUMMARY

In view of the above issue, the present disclosure is directed to providing a highly reliable liquid ejection head which lessens the risk of trapping an air bubble in an adhesive for bonding a protective member.

According to some embodiments, a liquid ejection head includes an ejection substrate including an ejection port row in a first surface, the ejection port row having a plurality of ejection ports configured to eject liquid arranged in the ejection port row, and a protective member configured to be bonded to the first surface of the ejection substrate via an adhesive, the protective member including a first opening corresponding to the ejection port row. The protective member further includes a second opening between the first opening and an outer edge of the protective member and outside a region where the ejection ports are formed, when viewed from a direction perpendicular to the first surface.

According to another aspect of the present disclosure, a liquid ejection head includes an ejection substrate including a plurality of ejection port rows in a first surface, the ejection port rows having a plurality of ejection ports configured to eject liquid arranged in the ejection port rows, and a protective member configured to be bonded to the first surface of the ejection substrate via an adhesive, the protective member including a plurality of first openings corresponding to the ejection port rows. The protective member further includes a second opening between the first openings adjacent to each other, when viewed from a direction perpendicular to the first surface.

Further features of the present disclosure will become apparent from the following description of exemplary embodiments with reference to the attached drawings.

### BRIEF DESCRIPTION OF THE DRAWINGS

FIG. 1 is a schematic configuration diagram of a liquid ejection apparatus.

FIG. 2 is a conceptual diagram illustrating a control system of the liquid ejection apparatus.

FIG. 3 is a schematic diagram of a liquid circulation path of the liquid ejection apparatus.

FIGS. 4A and 4B are perspective views of a liquid ejection head.

FIG. 5 is an exploded perspective view of the liquid ejection head.

FIGS. 6A to 6D are plan views of flow path members of the liquid ejection head.

FIGS. 7A and 7B are, respectively, a perspective view and a cross sectional view of a flow path with flow path members of the liquid ejection head as viewed from a side on which an ejection module is mounted.

FIGS. 8A and 8B are, respectively, perspective and exploded perspective views of the ejection module of the liquid ejection head.

FIG. 9A is a plan view of a surface of a device substrate where ejection ports are formed, FIG. 9B is a partially enlarged plan view of FIG. 9A, and FIG. 9C is a plan view of a back surface.

FIG. 10 is a cross-sectional perspective view taken along a line X-X in FIG. 9A, and is a cross-sectional perspective view of the device substrate and a lid member.

FIGS. 11A to 11D are simplified diagrams each illustrating the ejection module in a first exemplary embodiment.

FIGS. 12A to the 12C are diagrams illustrating a configuration in which a protective member having no external-to-ejection-port-region ports is bonded to the device substrate in a comparative example.

FIGS. 13A to 13C are diagrams illustrating a configuration in which a protective member having an external-to-ejection-port-region port is bonded to the device substrate in the first exemplary embodiment.

FIGS. 14A and 14B are top views illustrating a part of a process of bonding the protective member to the device substrate in the comparative example.

FIGS. 15A to 15C are cross-sectional views of the device substrate in a state where a water-repellent layer is arranged on the device substrate in a modification of the first exemplary embodiment.

FIGS. 16A to 16F are each a top view of a state in which the water-repellent layer is arranged on the device substrate in the modification of the first exemplary embodiment.

FIGS. 17A to 17F are each a top view of the device substrate in a state where an adhesive is applied to the device substrate in the modification of the first exemplary embodiment.

FIGS. 18A to 18C are each a schematic diagram illustrating an example of a protective member bonded to the device substrate illustrated in any one of FIGS. 17A to 17F in the modification of the first exemplary embodiment.

FIGS. 19A and 19B are perspective views of a device substrate in which a non-water repellent region has a recessed shape in a second exemplary embodiment.

FIG. 20 is a perspective view of a state in which a protective member is bonded to the device substrate illustrated in FIG. 19B in the second exemplary embodiment.

FIGS. 21A and 21B are cross-sectional views taken along a line XXI-XXI of FIG. 20 in the second exemplary embodiment.

FIGS. 22A to 22H are diagrams illustrating a method of forming a recessed portion in the device substrate in the second exemplary embodiment.

FIG. 23 is a schematic view of a protective member in a third exemplary embodiment.

FIG. 24 is a schematic diagram illustrating a cleaning operation on a liquid ejection head in the third exemplary embodiment.

FIGS. 25A and 25B are each a schematic diagram illustrating an example of another protective member according to the third exemplary embodiment.

FIG. 26 is a schematic view illustrating an example of a protective member in a fourth exemplary embodiment.

FIG. 27 is a schematic view illustrating an example of a protective member in a fifth exemplary embodiment.

### DESCRIPTION OF THE EMBODIMENTS

Hereinafter, various exemplary embodiments, features, and aspects of the present disclosure will be described with reference to the drawings. However, the following description does not limit the scope of the present disclosure. As an example, in exemplary embodiments, a thermal method is employed in which an air bubble is generated by a heating element to eject liquid. However, the present disclosure can also be applied to liquid ejection heads that employ a piezoelectric method using a piezoelectric element as an energy generating element for ejecting liquid, and other various liquid ejection methods. A liquid ejection head and a liquid ejection apparatus including the liquid ejection head according to the present disclosure are applicable to apparatuses, such as an inkjet printer, a copier, a facsimile machine provided with a communication system, and a word processor provided with a printer unit. Furthermore, the liquid ejection head and the liquid ejection apparatus are applicable to an industrial recording apparatus combined with various processing apparatuses in a complex manner. For example, the liquid ejection head and the liquid ejection apparatus can be used in applications, such as biochip production, electronic circuit printing, and semiconductor substrate production.

In the present exemplary embodiment, the liquid ejection apparatus is in a form in which liquid, such as ink, is circulated between a tank and the liquid ejection head is employed, but other forms may be employed. For example, a form may be employed in which instead of circulating the liquid as described above, the liquid flows from one of two tanks disposed upstream and downstream of a liquid ejection head to the other, making the liquid in the pressure chambers flow. In addition, while in the present exemplary embodiment, a so-called line type (page wide type) head having a length corresponding to the width of a recording medium is used, the present disclosure can also be applied to a so-called serial type liquid ejection head that performs recording while scanning a recording medium. The serial type liquid ejection head may have a configuration in which one device substrate for black ink and one device substrate for color inks are mounted, but the exemplary embodiment of the present disclosure is not limited to that configuration. A short line head shorter than the widths of recording media, in which several device substrates are arranged such that their ejection ports overlap in an ejection port row direction, may be produced to scan recording media.

### DISCRIPTION OF BASIC CONFIGURATION

### General Configuration of Apparatus

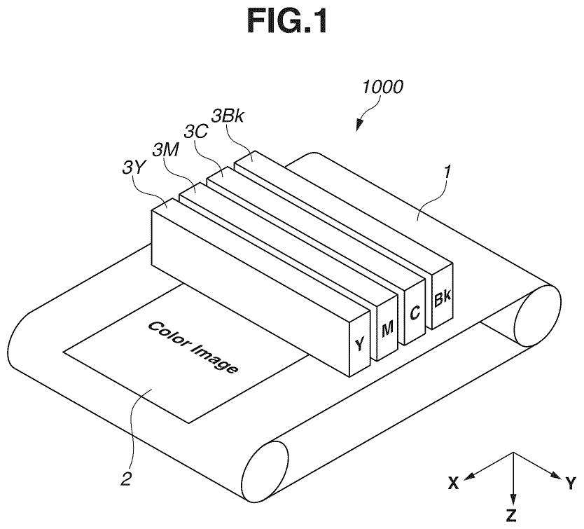

FIG. 1 is a diagram illustrating an example of a liquid ejection apparatus according to the present exemplary embodiment. The liquid ejection apparatus of the present exemplary embodiment is a liquid ejection apparatus 1000 (hereinafter, also simply referred to as an apparatus 1000) as an inkjet printer that records a color image on a recording medium 2 by ejecting yellow (Y), magenta (M), cyan (C), and black (Bk) inks. In FIG. 1, the X direction is a conveyance direction of the recording medium 2, the Y direction is a width direction of the recording medium 2, and the Z direction is a direction intersecting the X direction and the Y direction and is a direction in which liquid is ejected.

FIG. 1 illustrates the liquid ejection apparatus 1000 in which liquid ejection heads 3 directly applies ink to the recording medium 2 conveyed in the X direction. The recording medium 2 is placed on a conveyance unit 1, and conveyed in the X direction at a predetermined speed under the four liquid ejection heads 3 (3Y, 3M, 3C, and 3Bk) that eject different inks. In FIG. 1, the four liquid ejection heads 3 are arranged in the X direction in the order of 3Bk, 3C, 3M, and 3Y, and the inks are applied to the recording medium 2 in the order of black, cyan, magenta, and yellow. In each liquid ejection head 3, a plurality of ejection ports for ejecting ink are arranged in the Y direction.

While FIG. 1 illustrates a cut paper sheet as the recording medium 2, the recording medium 2 may be a continuous paper sheet supplied from a paper roll. The recording medium is not limited to paper, and may be made of, for example, a film.

In addition, in the present exemplary embodiment, the liquid ejection apparatus 1000 having a configuration in which one liquid ejection head ejects a single color ink is illustrated, but one liquid ejection head may be configured to eject a plurality of color inks. In addition, a liquid ejection head 3 may be configured to eject a liquid other than ink, such as a reaction liquid or an overcoat agent.

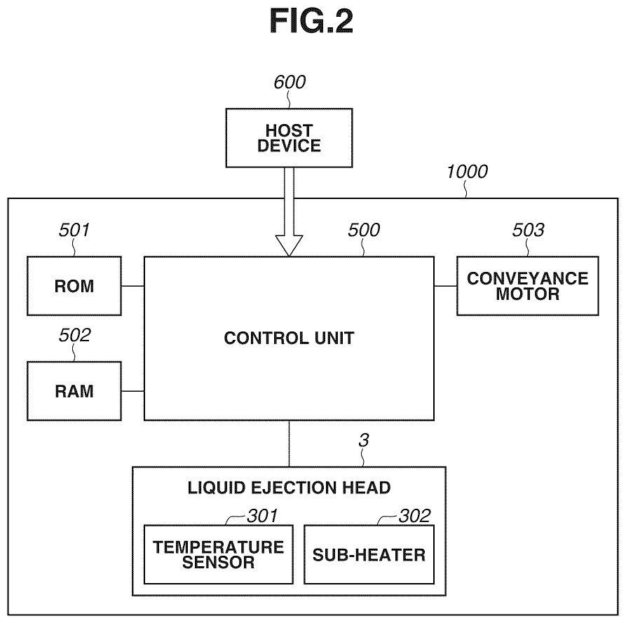

FIG. 2 is a block diagram for describing a configuration of control in the liquid ejection apparatus 1000. A control unit 500 includes a central processing unit (CPU) and other components, and generally controls the liquid ejection apparatus 1000 while using a random-access memory (RAM) 502 as a working area in accordance with programs and various kinds of parameters stored in a read-only memory (ROM) 501. The control unit 500 performs predetermined image processing on image data received from a host device 600 connected to the outside in accordance with programs and parameters stored in the ROM 501 to generate ejection data that each liquid ejection head 3 can eject with. Then, each liquid ejection head 3 is driven in accordance with the ejection data to eject the ink at a predetermined frequency.

During an ejection operation being performed by each liquid ejection head 3, the control unit 500 drives a conveyance motor 503 to convey the recording medium 2 in the X direction at a speed corresponding to the drive frequency. Through this process, an image in accordance with the image data received from the host device 600 is printed on the recording medium 2. In the ROM 501, information on operation regions of the ejection ports used for ejection from the liquid ejection heads 3 is stored in a rewritable manner for each liquid ejection head 3.

### Circulation Path of Liquid

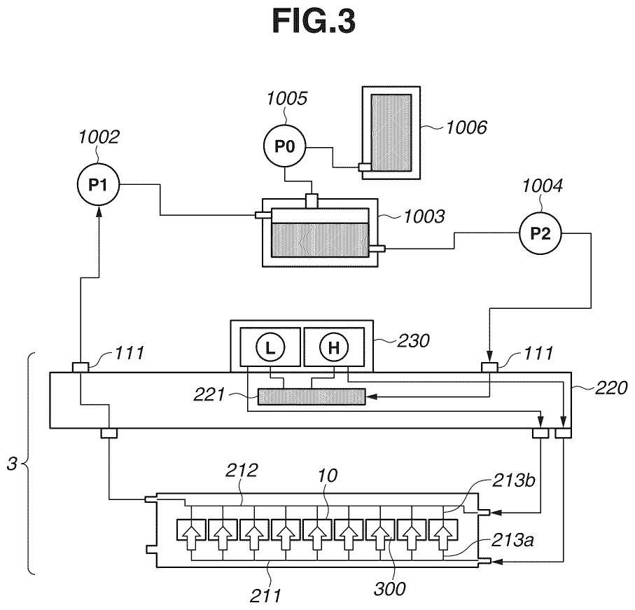

FIG. 3 is a schematic diagram illustrating a circulation path of liquid in the liquid ejection apparatus 1000 of the present exemplary embodiment, and is a diagram in which a liquid ejection head 3 is fluidly connected to a first circulation pump 1002, a buffer tank 1003, and other constituents. While FIG. 3 illustrates only a path through which the ink of the liquid ejection head corresponding to the ink of one color flows, the liquid ejection apparatus 1000 is provided with circulation paths each for the corresponding type of liquid of the types of liquid to be ejected, such as ink.

The buffer tank 1003 as a sub-tank connected to a main tank 1006 has an atmosphere communication port (not illustrated) that communicates with the inside and the outside of the sub-tank, and can vent air bubbles in the ink to the outside. The buffer tank 1003 is also connected to a replenishment pump 1005. When the liquid is consumed from the liquid ejection head 3 by the ink as the liquid being ejected from the ejection ports of the liquid ejection head 3, such as printing by the ink being ejected and suction recovery, the replenishment pump 1005 transfers the amount of the ink corresponding to the amount of the ink consumed from the main tank 1006 to the buffer tank 1003.

The first circulation pump 1002 has a role of drawing out the liquid from liquid connection portions 111 of the liquid ejection head 3 to cause the liquid to flow to the buffer tank 1003. When the liquid ejection head 3 is driven, the first circulation pump 1002 circulates a constant amount of the ink through a common collection flow path 212.

A negative pressure control unit 230 is disposed along the path between a second circulation pump 1004 and a liquid ejection unit 300. The negative pressure control unit 230 has a function of operation so as to keep the pressure downstream (on the liquid ejection unit 300 side) of the negative pressure control unit 230 at a preset constant pressure even when the flow rate of the circulation system fluctuates due to differences in recording duty.

As illustrated in FIG. 3, the negative pressure control unit 230 includes two pressure adjustment mechanisms, and control pressures different from each other are set for the respective pressure adjustment mechanisms. Of the two pressure adjustment mechanisms, the relatively high pressure setting side (a negative pressure control portion 230H, denoted by H in FIG. 3) and the relatively low pressure side (a negative pressure control portion 230L, denoted by L in FIG. 3) are connected via the inside of a liquid supply unit 220 to a common supply flow path 211 and the common collection flow path 212 in the liquid ejection unit 300, respectively. The liquid ejection unit 300 is provided with the common supply flow path 211, the common collection flow path 212, and an individual supply flow path 213a and an individual collection flow path 213b communicating with each device substrate 10 (each ejection substrate) having ejection ports. The device substrate 10 will be described in detail below. The individual flow paths 213 communicate with the common supply flow path 211 and the common collection flow path 212, so that part of the liquid circulated by the second circulation pump 1004 passes through the internal flow paths of the device substrates 10 from the common supply flow path 211 to the common collection flow path 212 (arrows in FIG. 3). This is because a pressure difference is set between the pressure adjustment mechanism H connected to the common supply flow path 211 and the pressure adjustment mechanism L connected to the common collection flow path 212, and the first circulation pump 1002 is connected only to the common collection flow path 212.

In this manner, in the liquid ejection unit 300, a flow of the liquid passing through the common collection flow path 212 and a flow of the liquid passing through the device substrates 10 from the common supply flow path 211 to the common collection flow path 212 are generated. This allows heat generated in each device substrate 10 to be transferred to the outside of the device substrate 10 by the flow from the common supply flow path 211 to the common collection flow path 212. In addition, such a configuration allows, when printing is performed by the liquid ejection head 3, a flow of the ink to be generated even in ejection ports and pressure chambers that are not engaging in printing, preventing thickening of the ink in those portions. In addition, that configuration allows ink with increased viscosity and foreign matter in the ink to be removed to the common collection flow path 212. This enables the liquid ejection head 3 of the present exemplary embodiment to perform high speed and high quality printing.

### Configuration of Liquid Ejection Head

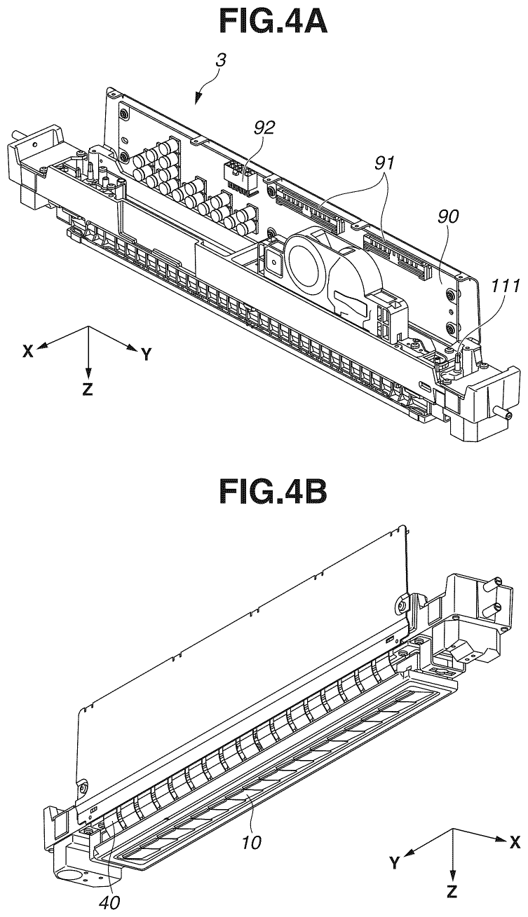

FIGS. 4A and 4B are perspective views of a liquid ejection head 3 according to the present exemplary embodiment. The liquid ejection head 3 is a line type liquid ejection head in which 17 device substrates 10 capable of ejecting ink are arranged in a straight line (in-line arrangement). As illustrated in FIGS. 4A and 4B, the liquid ejection head 3 includes the device substrates 10, and signal input terminals 91 and power supply terminals 92 which are electrically connected to the device substrates 10 through electric wiring boards (flexible electric wiring boards) 40 and an electric wiring board 90. The signal input terminals 91 and the power supply terminals 92 are electrically connected to the control unit 500 of the liquid ejection apparatus 1000 to supply ejection drive signals and power for ejection to the device substrates 10, respectively. By integrating wiring in electric circuitry in the electric wiring board 90, the number of the signal input terminals 91 and the power supply terminals 92 can be decreased compared with the number of the device substrates 10. This configuration reduces the number of electrical connection portions to be removed when the liquid ejection head 3 is attached to the liquid ejection apparatus 1000 or when the liquid ejection head 3 is replaced. As illustrated in FIG. 4A, the liquid connection portion 111 disposed on one side of the liquid ejection head 3 is connected to the liquid supply system of the liquid ejection apparatus 1000. This makes it possible for the ink to be supplied from the supply system of the liquid ejection apparatus 1000 to the liquid ejection head 3, and for the ink that has passed through the liquid ejection head 3 to be collected to the supply system of the liquid ejection apparatus 1000. In this manner, the ink can circulate through the path of the liquid ejection apparatus 1000 and the path of the liquid ejection head 3.

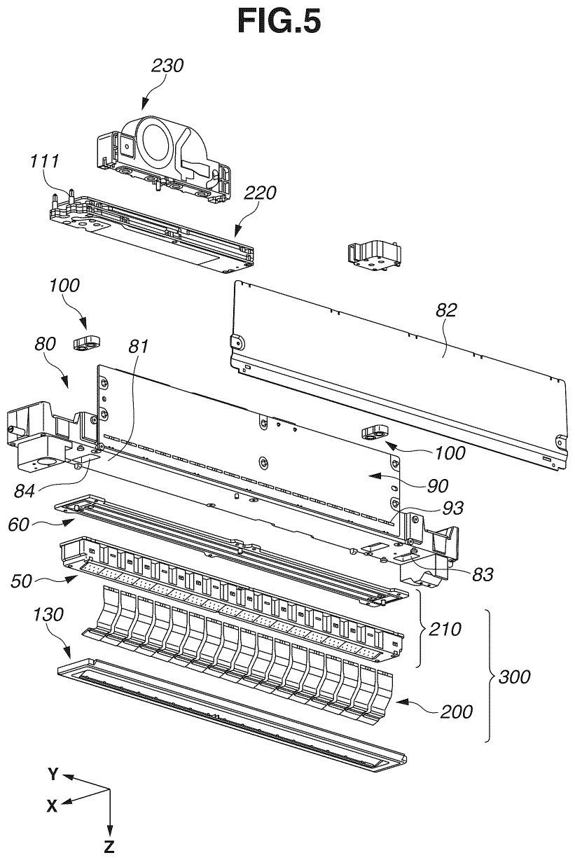

FIG. 5 is an exploded perspective view of individual components or units included in the liquid ejection head 3. The liquid ejection unit 300, the liquid supply unit 220, and the electric wiring board 90 are attached to a housing 80. The liquid supply unit 220 is provided with the liquid connection portions 111, and further includes a filter 221 (FIG. 3) that communicates with the individual ports in the liquid connection portions 111, inside the liquid supply unit 220 in order to remove foreign matter in the ink to be supplied. The liquid that has passed through the filter 221 is supplied to the negative pressure control unit 230 disposed on the liquid supply unit 220. The negative pressure control unit 230 is a unit including a pressure adjustment valve, and significantly decreases fluctuation in pressure loss in the supply system of the liquid ejection apparatus 1000 (the supply system upstream of the liquid ejection heads 3) caused by fluctuation in flow rate of the liquid by the actions of valves, spring members, or other constituents disposed in each unit.

This makes it possible to stabilize fluctuation in negative pressure downstream (on the liquid ejection unit 300 side) of the negative pressure control unit 230 within a certain range. The negative pressure control unit 230 has built-in two adjustment valves which are set to control pressures different from each other, and the high pressure side communicates with the common supply flow path 211 in the liquid ejection unit 300 and the low pressure side communicates with the common collection flow path 212 via the liquid supply unit 220.

The housing 80 includes a liquid ejection unit support portion 81 and an electric wiring board support portion 82 which support the liquid ejection unit 300 and the electric wiring board 90, and secure the rigidity of the liquid ejection head 3. The electric wiring board support portion 82 is used for supporting the electric wiring board 90, and is fixed to the liquid ejection unit support portion 81 with screws. The liquid ejection unit support portion 81 is provided with openings 83 and 84 for joint rubbers 100 to be inserted into. The liquid supplied from the liquid supply unit 220 is guided via the joint rubbers 100 to a second flow path member 60 included in the liquid ejection unit 300.

A configuration of the flow path member 210 included in the liquid ejection unit 300 will now be described. In the flow path member 210 as illustrated in FIG. 5, a first flow path member 50 and the second flow path member 60 are stacked. A plurality of ejection modules 200 is bonded to a bonding surface of the first flow path member 50 by an adhesive (not illustrated). The flow path member 210 is used for distributing the liquid supplied from the liquid supply unit 220 to each of the ejection modules 200 and returning the liquid flowing out of the ejection modules 200 to the liquid supply unit 220. The flow path member 210 is fixed to the liquid ejection unit support portion 81 with screws, reducing warpage and deformation of the flow path member 210.

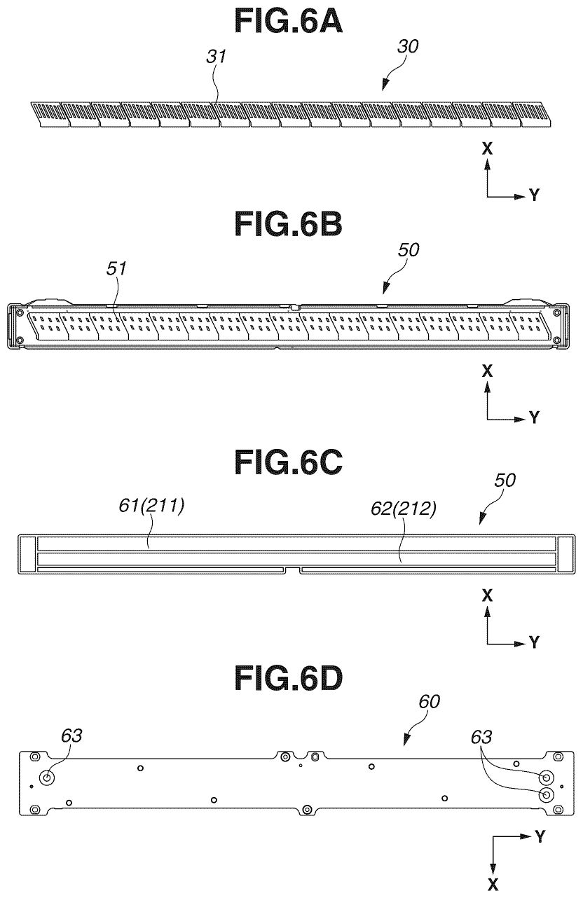

FIGS. 6A to 6D are diagrams for describing a detailed configuration of the flow path member 210. FIG. 6A illustrates support members 30 disposed on a surface of the first flow path member 50 as the side on which the ejection modules 200 are mounted, and FIG. 6B illustrates a contact surface of the first flow path member 50 with the support members 30. FIG. 6C illustrates a cross-sectional view of a surface of the first flow path member 50 that is perpendicular to the Z direction and near the center in the Z direction, and FIG. 6D illustrates a surface of the second flow path member 60 as the side that is to be brought into contact with the liquid ejection unit support portion 81. In addition, FIGS. 6A to 6C are views from the ejection modules 200 side, and FIG. 6D is a view from the liquid ejection unit support portion 81 side.

The plurality of support members 30 arranged in the Y direction is disposed on the surface of the first flow path member 50 opposite to the second flow path member 60, and one device substrate 10 is disposed on each support member 30. By adjusting the number of the ejection modules 200 arranged, it is possible to configure liquid ejection heads 3 of various sizes.

As illustrated in FIG. 6A, the support members 30 have, in a surface in contact with the device substrates 10, communication ports 31 that are fluidly connected to the device substrates 10 and serve as the individual supply flow paths 213a and the individual collection flow paths 213b described above with reference to FIG. 3. As illustrated in FIG. 6B, the communication ports 31 are in fluid communication with the common supply flow path 211 or the common collection flow path 212 via communication ports 51 in the first flow path member 50.

As illustrated in FIG. 6C, in the middle layer near the center of the first flow path member 50 in the Z direction, common flow path grooves 61 and 62 serving as the common supply flow path 211 and the common collection flow path 212, respectively, described in FIG. 3 extend in the Y direction. As illustrated in FIG. 6D, common communication openings 63 that fluidly communicate with the liquid supply unit 220 are formed at both ends or one end of the common flow path grooves 61 and 62.

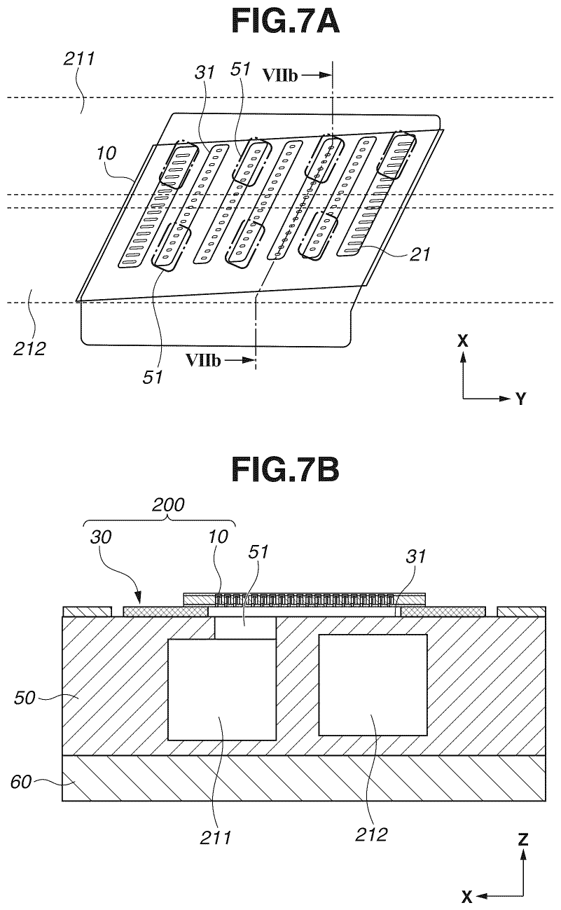

FIGS. 7A and 7B are a perspective view and a cross sectional view for describing a flow path structure formed inside the liquid ejection unit 300. FIG. 7A is an enlarged perspective view of the flow path member 210 as viewed from the Z direction, and FIG. 7B is a cross-sectional view taken along a line VIIb-VIIb of FIG. 7A.

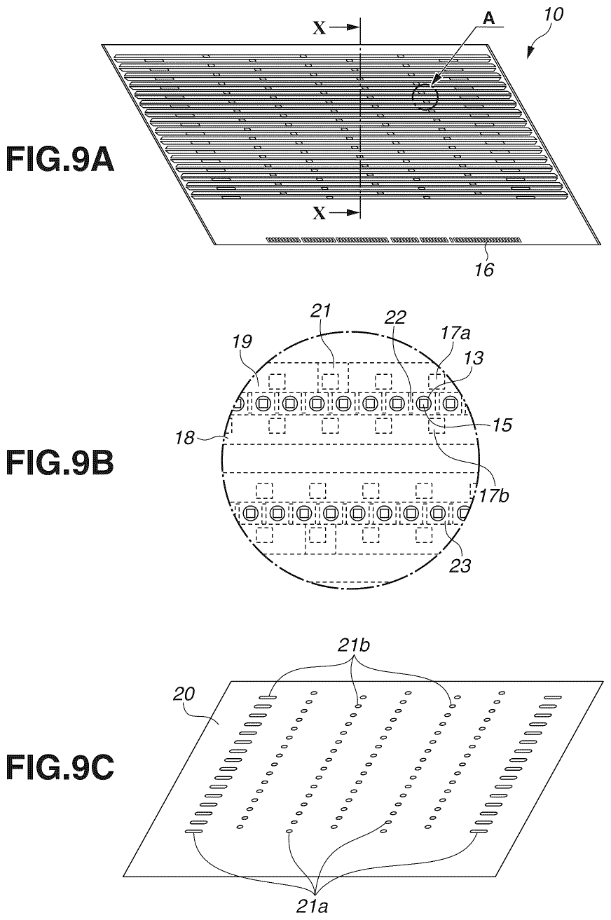

The device substrates 10 of the ejection modules 200 are placed over the communication ports 51 in the first flow path member 50 via the support members 30. In FIG. 7B, only a communication port 51 corresponding to the common supply flow path 211 is illustrated, but in another cross section, the common collection flow path 212 and the communication ports 51 communicate with each other as illustrated from FIGS. 6A to 6D. The support member 30 and the device substrate 10 included in each ejection module 200 are provided with a flow path for supplying the ink from the first flow path member 50 to heat generation resistance elements 15 (see FIG. 9B) disposed on the device substrate 10. Furthermore, the support member 30 and the device substrate 10 are provided with a flow path for collecting (circulating) a part or all of the liquid supplied to the heat generation resistance elements 15 to the first flow path member 50.

As described above, the common supply flow path 211 is connected to the negative pressure control portion 230H having a relatively high pressure, and the common collection flow path 212 is connected to the negative pressure control portion 230L having a relatively low pressure. An ink supply path is formed to supply the ink to the flow path formed in the device substrate 10 through the common communication openings 63 (see FIG. 6D), the common supply flow path 211, and the communication ports 31. Similarly, an ink collection path including the communication ports 31, the communication ports 51, the common collection flow path 212, and the common communication opening 63 (see FIG. 6D) is formed from the flow path in the device substrate 10. While the ink is circulated in this manner, in the device substrates 10, the ejection operation is performed in accordance with the ejection data, and the ink that is not consumed by the ejection operation among the ink supplied through the ink supply path is collected through the ink collection path.

### Configuration of Ejection Module

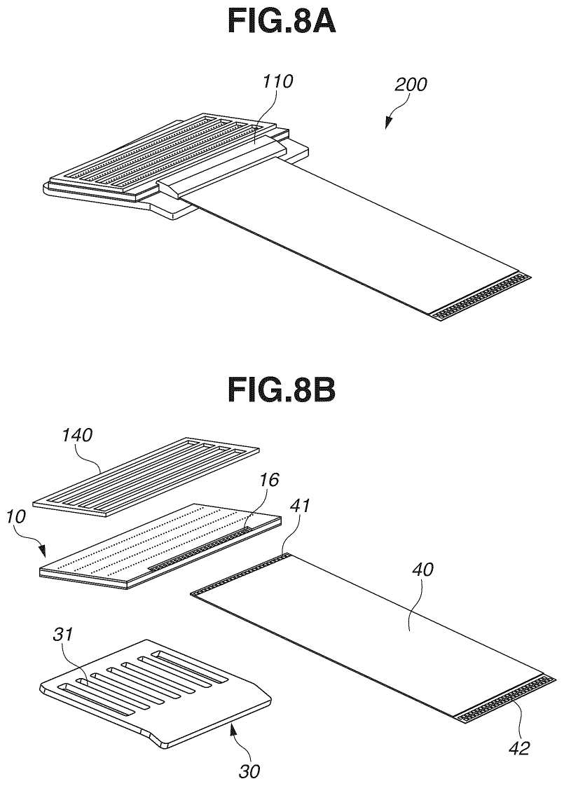

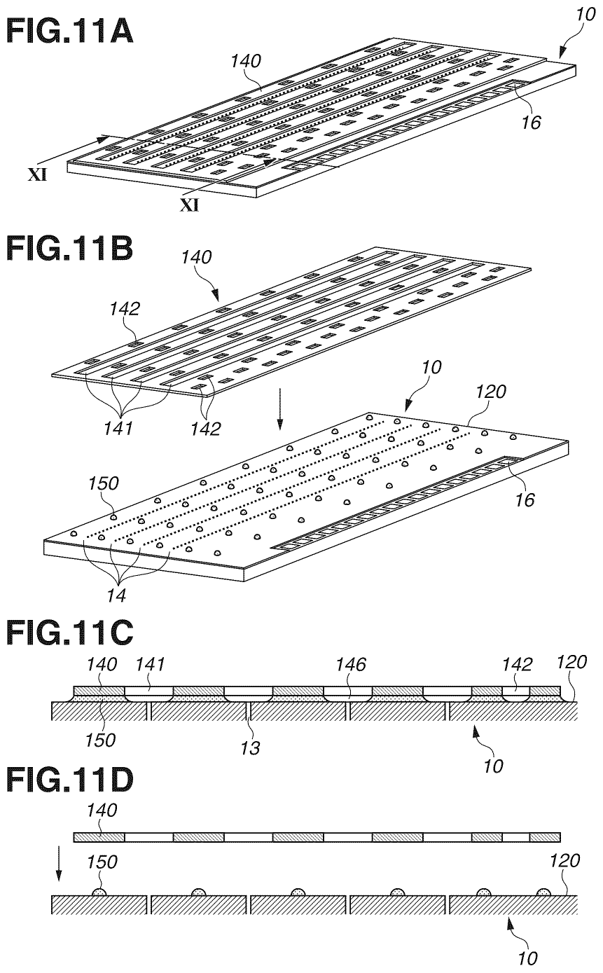

FIG. 8A is a perspective view of one ejection module 200, and FIG. 8B is an exploded view thereof. First, a protective member 140 is bonded to a device substrate 10 using an adhesive. Thereafter, the device substrate 10 to which the protective member 140 is bonded and a flexible electric wiring board 40 are bonded on a support member 30 in which the communication ports 31 are provided in advance. Further, a terminal 16 on the device substrate 10 and a terminal 41 on the flexible electric wiring board 40 are electrically connected to each other by wire bonding, and then the wire bonding portion (electrical connection portion) is covered with a sealing material to form a sealing portion 110. A terminal 42 of the flexible electric wiring board 40 opposite to the device substrate 10 is electrically connected to a connection terminal 93 (see FIG. 5) of the electric wiring board 90. The support member 30 supports the device substrate 10 and is a flow path member via which the device substrate 10 and the flow path member 210 fluidly communicate with each other. Thus, it is preferable that the support member 30 has high flatness and can be bonded to the device substrate 10 with sufficiently high reliability. As the material, for example, alumina or a resin material is preferable. The protective member 140 is bonded to an ejection surface 120 (see FIG. 11B to 11D) of the device substrate 10 via an adhesive, and has openings 141 each for the corresponding ejection port row of ejection port rows 14. The protective member 140 serves to prevent contact between the recording medium 2 and the device substrate 10, and can lessen the risk of damage to the liquid ejection head 3. For that reason, the material of the protective member 140 preferably has a higher elastic modulus than that of an ejection port forming member 12 made of a resin material. As the material, for example, a metal material, such as stainless steel or aluminum, silicon, or alumina, can be suitably used. In addition, as the material of the protective member 140, use of a material having substantially the same coefficient of linear expansion as that of the material of the device substrates 10 makes it possible to lessen the risk of the protective member 140 peeling off from the ejection port forming member 12. The outer shapes of the protective member 140 and each opening 141 are preferably processed with high accuracy. As a processing method, for example, etching, laser processing, or mechanical processing can be suitably used. Further, the processing method may be changed for the front or the back and positions on the protective member 140.

### Configuration of Device Substrate

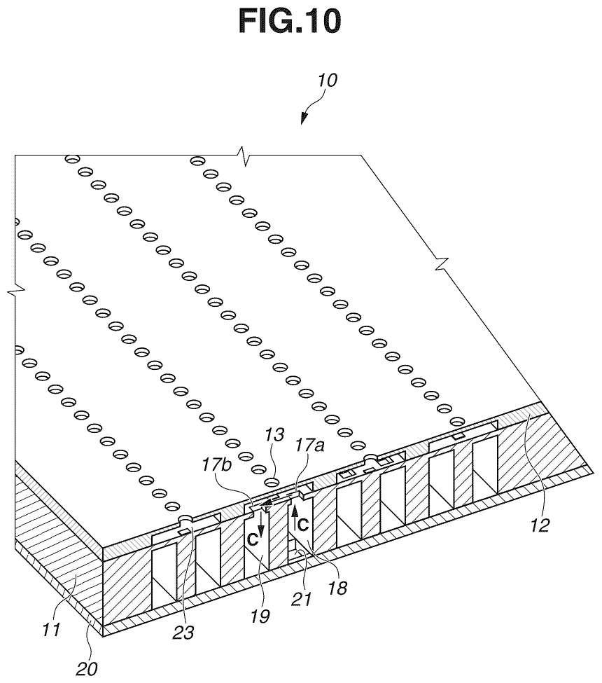

A configuration of each device substrate 10 in the present exemplary embodiment will be described. FIG. 9A illustrates a plan view of the surface of the device substrate 10 where ejection ports 13 are formed, FIG. 9B illustrates an enlarged view of the portion indicated by A in FIG. 9A, and FIG. 9C illustrates a plan view of the back surface of the device substrate 10 in FIG. 9A. FIG. 10 is a cross-sectional perspective view of the device substrate 10 taken along a line X-X in FIG. 9A. Hereinafter, a direction in which the ejection port rows 14 in which the plurality of ejection ports 13 are arranged extend is referred to as an “ejection port row direction”.

As illustrated in FIG. 9B, the heat generation resistance elements 15, which are a heat generation element (a pressure generation element) for making a bubble in the liquid using heat energy generated from the heat generation element, are each disposed at the position of the corresponding ejection port of the ejection ports 13. Pressure chambers 23 each including a heat generation resistance element 15 therein are defined by a partition wall 22 formed in a first layer 121 (described below) of the ejection port forming member 12. The heat generation resistance element 15 is electrically connected to the terminal 16 by electric wiring (not illustrated) disposed on the device substrate 10. The heat generation resistance element 15 generates heat to boil the liquid based on pulse signals input from a control circuit of the liquid ejection apparatus 1000 via the electric wiring board 90 (see FIG. 5) and the flexible electric wiring board 40 (see FIGS. 8A and 8B). The force of a bubble made due to the boiling causes the liquid to be ejected from the ejection port 13. As illustrated in FIG. 9B, a liquid supply path 18 extends on one side of each ejection port row, and a liquid collection path 19 extends on the other side. The liquid supply path 18 and the liquid collection path 19 are flow paths arranged in the device substrate 10 and extending in the ejection port row direction, and communicate with the ejection ports 13 via supply ports 17a and collection ports 17b, respectively. FIGS. 9A to 9C illustrate, as an example, the device substrate 10 including a plurality of ejection port rows, specifically, 16 ejection port rows.

As illustrated in FIGS. 9C and 10, a sheet-like cover plate 20 is laminated on the back surface relative to the surface of the device substrate 10 where the ejection ports 13 are formed. As illustrated in FIG. 9C, a plurality of ports 21, which will be described below, communicating with the liquid supply paths 18 and the liquid collection paths 19 is disposed in the cover plate 20. In the present exemplary embodiment, four supply ports 21a are disposed for one liquid supply path 18, and three collection ports 21b are disposed for one liquid collection path 19, but the numbers of those ports are not limited thereto. As illustrated in FIG. 9B, the individual ports 21 in the cover plate 20 communicate with the communication ports 51 illustrated in FIG. 7A. The cover plate 20 is preferably made of a material having sufficient corrosion resistance against the liquid, and the port shapes and the port positions of the ports 21 are to be highly accurate so that the ink is supplied to the pressure chambers 23. For that reason, it is preferable to use a photosensitive resin material or a silicon plate as the material of the cover plate 20 to provide the ports 21 by the photolithography technology. As described above, the cover plate 20 changes the pitch of the flow paths by the ports 21, and the cover plate 20 is desirably formed of a film-like member having a thickness of about 30 to 600 micrometers (μm) from the viewpoint of pressure loss, strength, and workability.

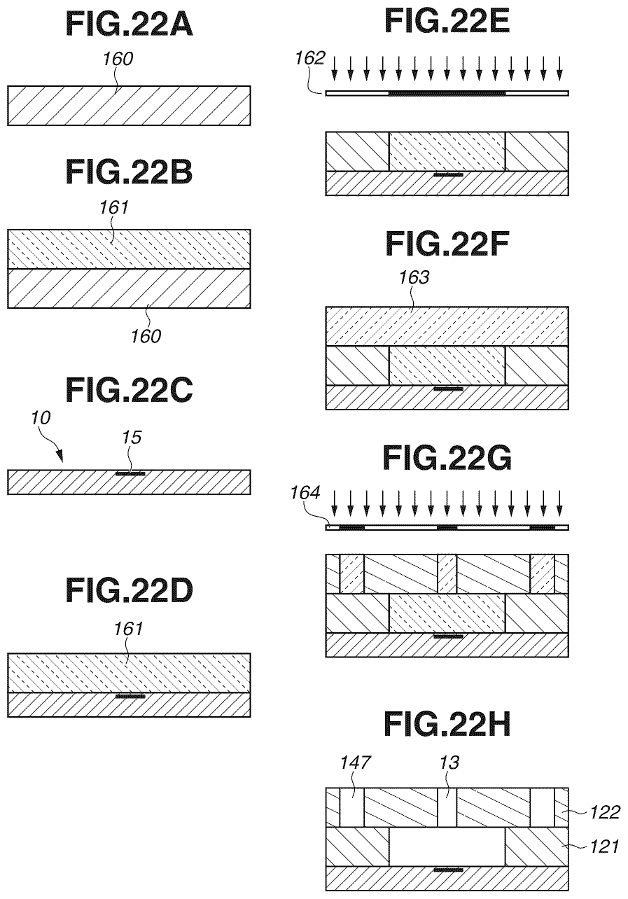

The flow of liquid in the device substrate 10 will now be described. The device substrate 10 is formed by stacking a substrate 11 made of silicon and the ejection port forming member (flow path forming member) 12 made of a photosensitive resin. In the present exemplary embodiment, the ejection port forming member 12 includes a first layer 121 (middle layer) for forming the pressure chambers 23 and a second layer 122 (upper layer) having the ejection ports 13 (see FIG. 22H). The first layer 121 and the second layer 122 are laminated on a surface of the substrate 11 in that order. The first layer 121 and the second layer 122 are patterned through exposure to light having optimum photosensitive wavelengths for the respective layers, and then developed, forming the ejection port forming member 12. As a method of manufacturing the ejection port forming member 12, any manufacturing method, such as a method of forming the pressure chambers 23 and the ejection ports 13 using a mold material or another material, can be used, in addition to the above described method of stacking the first layer 121 and the second layer 122. The cover plate 20 is bonded to the back surface of the substrate 11. The cover plate 20 has a function as a lid that forms a part of the walls of the liquid supply paths 18 and the liquid collection paths 19 formed in the substrate 11 of the device substrate 10. The heat generation resistance elements 15 are formed on one surface of the substrate 11 of the device substrate 10 (see FIG. 9B), and grooves forming the liquid supply paths 18 and the liquid collection paths 19 extending along the ejection port rows are formed in the back surface of the substrate 11. The liquid supply paths 18 and the liquid collection paths 19 formed with the substrate 11 and the cover plate 20 are connected to the common supply flow path 211 and the common collection flow path 212 in the flow path member 210, respectively (see FIGS. 7A and 7B), and a differential pressure is generated between each liquid supply path 18 and the corresponding liquid collection path 19. This differential pressure generates a circulation flow C in which the liquid in each liquid supply path 18 arranged in the substrate 11 flows to the corresponding liquid collection path 19 via the supply ports 17a, the pressure chambers 23, and the collection ports 17b (flow indicated by arrows C in FIG. 10). This flow allows thickened ink, bubbles, foreign matter, and the like, all of which are generated due to evaporation from the ejection ports 13, in the ejection ports 13 and the pressure chambers 23 that are not performing the ejection operation to be collected to the liquid collection paths 19. In addition, this can prevent the ink in the ejection ports 13 and the pressure chambers 23 from thickening and prevent the concentration of the color material from increasing. As illustrated in FIGS. 7A and 7B, the liquid collected in the liquid collection paths 19 is collected in the order of the communication ports 31 in the support members 30, the communication ports 51 in the first flow path member 50, and the common collection flow path 212 through the ports 21 in the cover plate 20 and the communication ports 31 in the support members 30, and is collected in the supply path of the liquid ejection apparatus 1000.

That is, the liquid supplied from the main body of the liquid ejection apparatus 1000 to the liquid ejection head 3 flows in the following order to be supplied and collected. The liquid first flows into the liquid ejection head 3 from a part of the liquid connection portion 111 of the liquid supply unit 220. Then, the liquid is supplied to one of the joint rubbers 100, the common communication openings 63 arranged in the second flow path member 60, the common flow path groove 61 arranged in the first flow path member 50, and the communication ports 51 in that order. Thereafter, the liquid is supplied via the communication ports 31 arranged in the support members 30, the ports 21 arranged in the cover plates 20, and the liquid supply paths 18 and the supply ports 17a arranged in the substrates 11 in that order, to the pressure chambers 23. Of the liquid supplied to the pressure chambers 23, the liquid that has not been ejected from the ejection ports 13 flows through the collection ports 17b and the liquid collection paths 19 arranged in the substrates 11, the ports 21 arranged in the cover plates 20, and the communication ports 31 arranged in the support members 30 in that order. Thereafter, the ink flows through the communication ports 51 and the common flow path 62 arranged in the first flow path member 50, the common communication openings 63 arranged in the second flow path member 60, and the other of the joint rubbers 100 in that order. Then, the liquid flows from the other(s) of the liquid connection portions 111 arranged in the liquid supply unit to the outside of the liquid ejection head 3. In the form of the circulation path illustrated in FIG. 3, the liquid flowing in from the part of the liquid connection portion 111 is supplied to the corresponding joint rubbers 100 after passing through the negative pressure control unit 230.

The liquid ejection head 3 according to the present exemplary embodiment further includes a temperature adjustment mechanism (not illustrated) in the device substrate 10. The device substrate 10 is divided into a plurality of areas for temperature adjustment, and a temperature sensor 301 and a sub-heater 302 that are individually controllable are disposed on each area. The control unit 500 (see FIG. 2) performs temperature adjustment based on a temperature (a target temperature) set for each area using the temperature sensor 301 and the sub-heater 302. That is, the control unit 500 drives the sub-heater(s) 302 only in an area or areas where the temperature detected by the temperature sensor(s) 301 is equal to or lower than the target temperature. By setting the target temperature of the device substrate 10 to a relatively high temperature, the viscosity of the ink is reduced, allowing appropriate ejection operation and circulation. This temperature control reduces the variations in temperature in the device substrate 10 and the variations in temperature among the plurality of device substrates 10 within a predetermined range. This reduces the variations in amount of liquid ejection due to temperature variations, reducing density unevenness in printed images. The target temperature of the device substrates 10 is preferably set to a temperature equal to or higher than an equilibrium temperature of the device substrates 10 when all the heat generation resistance elements 15 are driven at an anticipated highest drive frequency. As the temperature sensors 301, a diode sensor, an aluminum sensor, or the like can be applied. The heat generation resistance elements 15 as a heat generation element can also be used as a heating element of the device substrate 10. Specifically, it is sufficient that the device substrate 10 is heated by applying a voltage to the heat generation resistance elements 15 to such an extent that the heat generation resistance elements 15 will not cause a bubble to be made. For example, the heat generation resistance elements 15 may be employed as the heating element instead of the sub-heaters 302, or the sub-heaters 302 and the heat generation resistance elements 15 may be used in combination.

In the present exemplary embodiment, the material of the ejection port forming member 12 is a photosensitive resin, but the present disclosure is not limited thereto. For example, the configuration of the present exemplary of the present disclosure can be favorably applied even in a case where silicon, metal, ceramic, glass, or another material is used.

### DESCRIPTION OF EXEMPLARY EMBODIMENTS

A first exemplary embodiment of the present disclosure will be described. Description of functions and configurations similar to those of the basic configuration described above will be omitted, and different points will be described.

FIG. 11A is a schematic perspective view of an ejection module in the first exemplary embodiment. FIG. 11B is a schematic view illustrating a state where an adhesive is applied. FIG. 11C is a cross-sectional view taken along a line XI-XI of FIG. 11A. FIG. 11D is a schematic view illustrating a state in which the adhesive is applied, taken along the line XI-XI in FIG. 11A. In FIGS. 11A and 11B, the configuration is partially simplified for easy understanding.

In the first exemplary embodiment, the ejection surface 120 is in a non-water-repellent state, and an adhesive 150 is applied in a dotted state on the ejection surface 120. The protective member 140 has ports 142 external to an ejection port region (also, referred to as external-to-ejection-port-region ports 142) at positions corresponding to the centers between positions of applied adhesive 150. Here, the openings 141 in the protective member 140 corresponding to the ejection port rows 14 and configured to expose the ejection port rows 14 are referred to as first openings. In this case, some parts of the external-to-ejection-port-region ports 142 are second ports arranged between the first openings 141 and the outer edge of the protective member 140 when viewed from the direction perpendicular to the ejection surface 120. Unlike the openings 141, the ports 142 do not correspond to the ejection ports 13 and the ejection port rows 14. Other parts of the external-to-ejection-port-region ports 142 are second ports arranged between the adjacent first openings 141 when viewed from the direction perpendicular to the first surface which is the ejection surface 120.

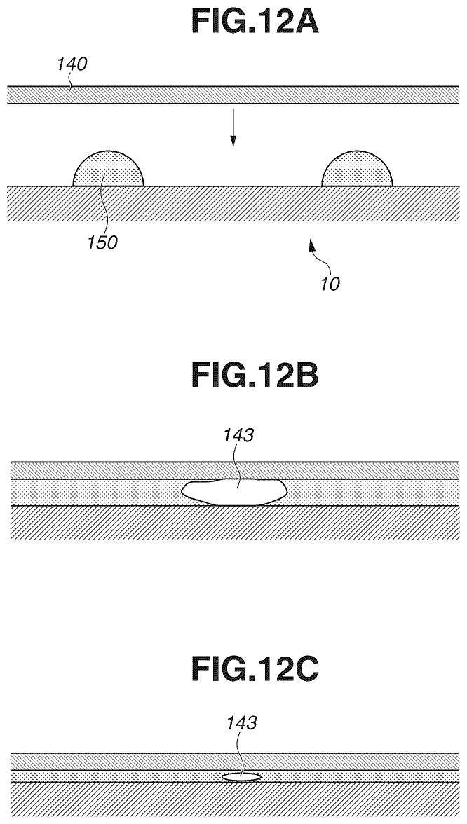

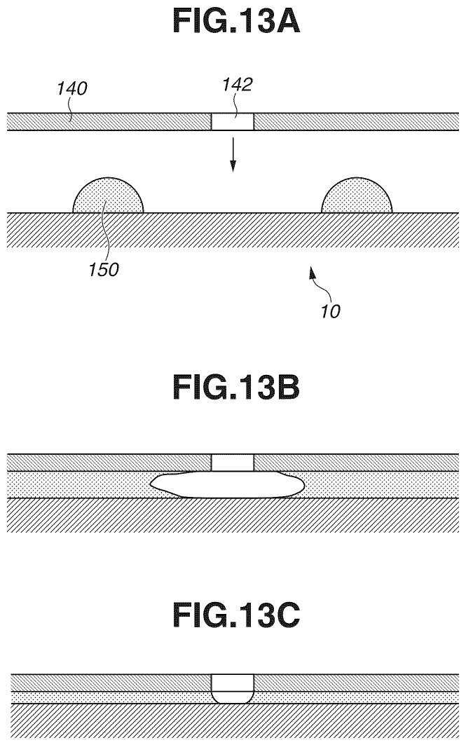

FIGS. 12A to 12C illustrate a process in which a protective member 140 without the external-to-ejection-port-region ports 142 is bonded to a device substrate 10. FIG. 12A illustrates a state before the protective member 140 is bonded, and FIG. 12B illustrates a state in which the protective member 140 is bonded and two positions where the adhesive 150 is applied are close to each other. FIG. 12C illustrates a state in which the protective member 140 is completely joined and an air bubble 143 is trapped in. FIGS. 13A to 13C illustrate a process in which the protective member 140 provided with the external-to-ejection-port-region ports 142 is bonded to a device substrate 10. FIG. 13A illustrates a state before the protective member 140 is bonded, and FIG. 13B illustrated a state in which the protective member 140 is bonded and two positions where the adhesive 150 is applied are close to each other. FIG. 13C illustrates a state in which the protective member 140 is completely joined. In the configuration of the present exemplary embodiment, the air bubble 143 will not be trapped in because an external-to-ejection-port-region port 142 is present. It is effective to provide the second ports 142 at positions in a large bonding area between the protective member 140 and the device substrate 10 in terms of reducing the trapping of air bubbles. In particular, second ports 142 are preferably arranged between a first opening 141 and a terminal row in which a plurality of terminals 16 are arranged, when viewed from the direction perpendicular to the ejection surface 120.

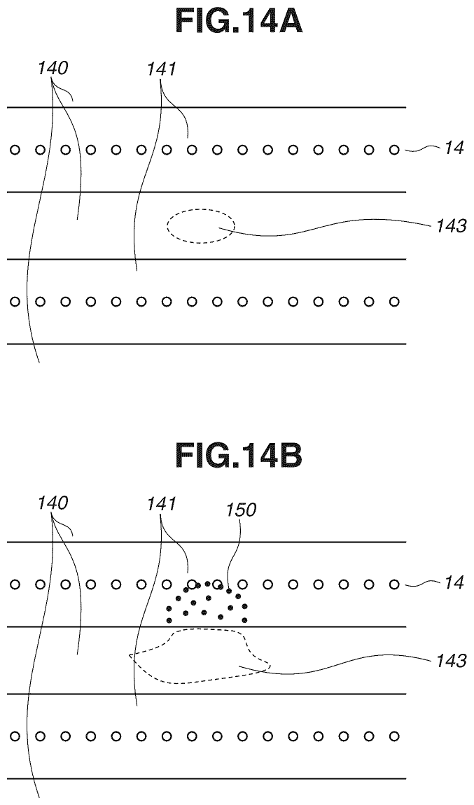

FIGS. 14A and 14B illustrate a state in which a heating process for curing the adhesive 150 is performed with the air bubble 143 trapped in the adhesive 150. FIG. 14A illustrates the state of FIG. 12C seen from above, and FIG. 14B illustrates the state in which the adhesive 150 is cured by further heating. FIG. 14B illustrates a state where the adhesive 150 is scattered around some ejection ports 13 through rupture of the air bubble 143 that expanded by heat. In the first exemplary embodiment, as an example, the size of each ejection port is Φ20 μm, the ejection port pitch corresponds to 600 dots per inch (dpi), the number of the ejection ports 13 in one row is 512, the number of the ejection port rows 14 is four, and the intervals between the ejection port rows are 500 μm. The protective member 140 is made of Steel Use Stainless (SUS) 303 and has a thickness of 30 μm, each opening 141 in the ejection port region (also, referred to as the ejection-port-region opening 141) has an opening width of 300 μm, each external-to-ejection-port-region port 142 has a size of 100 μm×100 μm, and the pitch between the ejection port rows are 500 μm. As the adhesive, an epoxy adhesive, for example, EA-421-B5 (manufactured by Sanyu Rec Co., Ltd.) was used. The adhesive was heated at 150° C. for one minute (min) on a hotplate and then at 150° C. for 60 min in an oven.

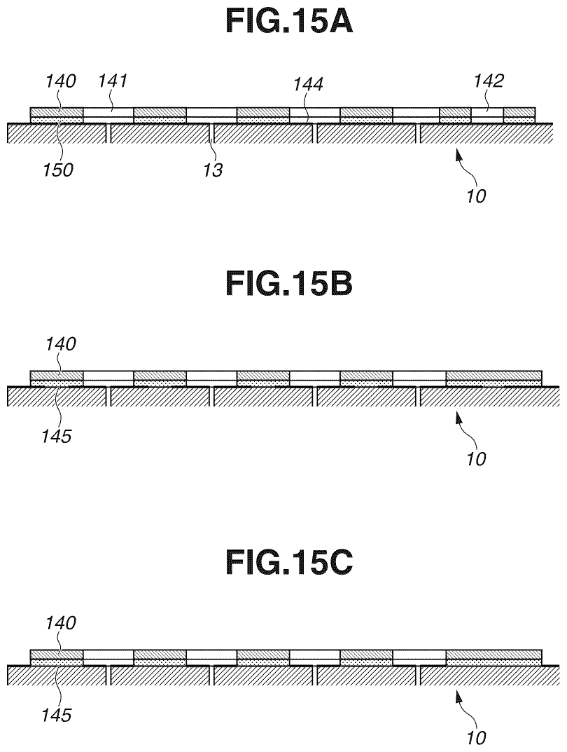

In addition, in the above described exemplary embodiment, the ejection surface 120 is not water-repellent, but as a modification example, a water repellent layer 144 may be disposed on the ejection surface 120. FIG. 15A illustrates a schematic cross sectional view of a state where the entire ejection surface 120 is water-repellent, FIG. 15B illustrates a state where a region to which the adhesive 150 is applied is a non-water-repellent region 145, and FIG. 15C illustrates a state where a region to which the protective member 140 is bonded is a non-water-repellent region 145. If the ejection surface 120 is not water-repellent, adhesive trailing 146 is generated as illustrated in FIG. 11C. Although it is difficult to control the amount of the adhesive trailing 146, with the water repellent layer 144 provided, the adhesive 150 will not substantially flow to the outside of the region of the protective member 140 even when the protective member 140 is bonded, so that the adhesive trailing 146 does not occur, making the control easy.

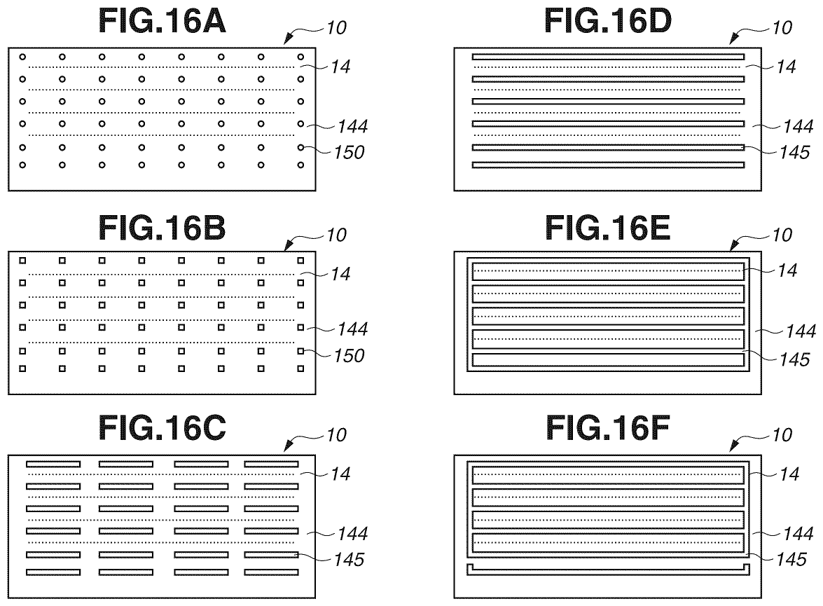

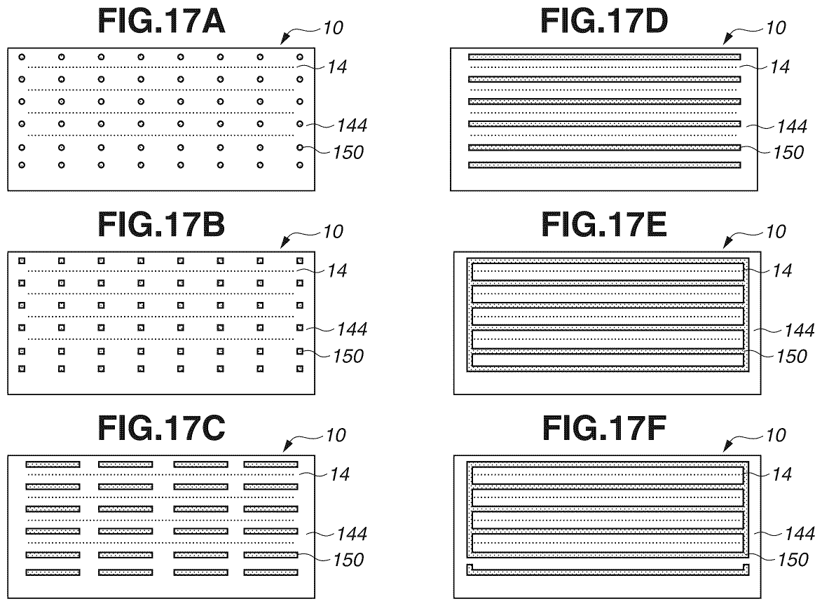

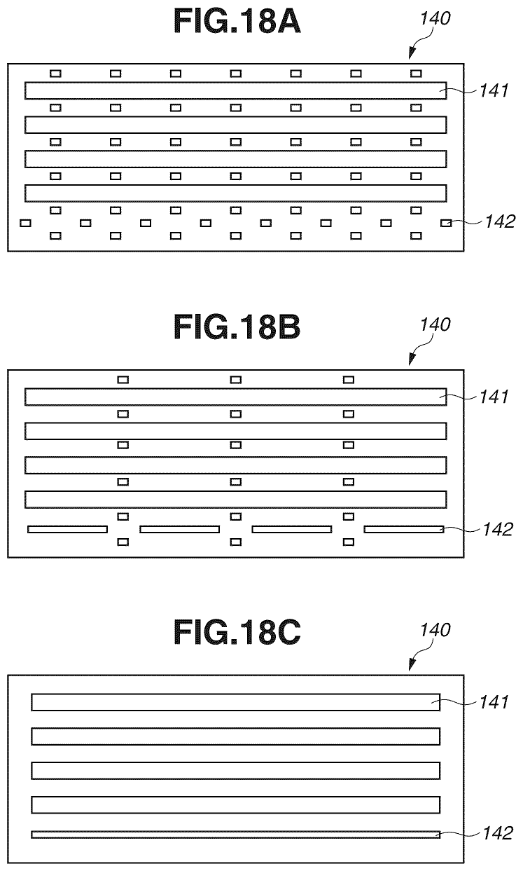

FIGS. 16A to 16F illustrate various shapes of the non-water-repellent region 145 arranged on the ejection surface 120. FIG. 16A illustrates a substantially circular shape as the shape of the non-water-repellent region 145, FIG. 16B illustrates a substantially square shape as the shape of the non-water-repellent region 145, and FIG. 16C illustrates a rectangular shape as the shape of the non-water-repellent region 145. In FIG. 16D, the non-water-repellent region 145 is continuously formed substantially parallel to the ejection port rows 14 for the length of the ejection port rows 14. In FIG. 16E, the non-water-repellent region 145 is formed surrounding each of the ejection port rows 14, and the non-water-repellent region 145 is formed continuously connecting to a region where no ejection port rows 14 are formed. In FIG. 16F, a part of the non-water-repellent region 145 illustrated in FIG. 16E on the outer periphery of the external-to-ejection-port-region ports 142 is disconnected when the protective member 140 is bonded. In both of FIGS. 16E and 16F, parts of the non-water-repellent region 145 corresponding to different ejection port rows 14 are continuously connected. FIGS. 17A to 17F each illustrate a state in which the adhesive 150 is applied to each part of the non-water-repellent region 145 in FIGS. 16A to 16F. FIG. 18A illustrates the protective member 140 to be joined to the ejection surface 120 in FIGS. 17A and 17B. Further, FIG. 18B illustrates the protective member 140 to be joined to the ejection surface 120 in FIG. 17C. FIG. 18C illustrates the protective member 140 to be joined to the ejection surface 120 in FIGS. 17D to 17F. An increased adhesion region results in increase in the adhesion force, improving the adhesion reliability. The configurations in FIGS. 16A to 16F, FIGS. 17A to 17F, and FIGS. 18A to 18C are partially simplified for easy understanding.

With too large openings 141 and too large external-to-ejection-port-region ports 142 in the protective member 140, if the recording medium 2 is lifted due to a paper jam or another cause during the conveyance, the recording medium 2 and the device substrate 10 will become high likely to come into contact with each other, damaging the liquid ejection head 3. In addition, from the viewpoint of the strength of the protective member 140, it is desirable that the total area of the openings 141 and the external-to-ejection-port-region ports 142 be not too large. For that reason, the total area of the openings 141 and the external-to-ejection-port-region ports 142 in the protective member 140 is desirably 90% or less, more desirably 80% or less, and still more desirably 70% or less of the area of the main plane of the protective member 140 (the opening ratio). The width of each opening 141 may be equal to or larger than the diameter of each ejection port 13 and smaller than the intervals between the adjacent ejection port rows 14, and the thickness of the protective member 140 may be equal to or smaller than the thickness of the device substrate 10. For example, it is preferable that the width of each opening 141 is 200 μm or more and the thickness of the protective member 140 is less than 50 μm. This makes it possible to reduce the stress when the recording medium 2 and the device substrate 10 come into contact with each other while ensuring cleaning performance around the ejection ports 13, reducing the possibility of damaging the liquid ejection head 3. Further, even if the recording medium 2 comes into contact with some ejection ports 13 and foreign matter, such as dust, is put into a pressure chamber 23, the liquid in the pressure chamber 23 is circulated between the pressure chamber 23 and the outside of the pressure chamber 23, causing the liquid to flow to the outside of the pressure chamber 23.

The minimum opening width of each external-to-ejection-port-region port 142 is desirably 5 μm or more, more desirably 10 μm or more, and still more desirably 15 μm or more so that air is reliably released when the protective member 140 is bonded.

A second exemplary embodiment of the present disclosure will be described. Description of functions and configurations similar to those of the basic configuration described above and the first exemplary embodiment will be omitted, and different points will be described.

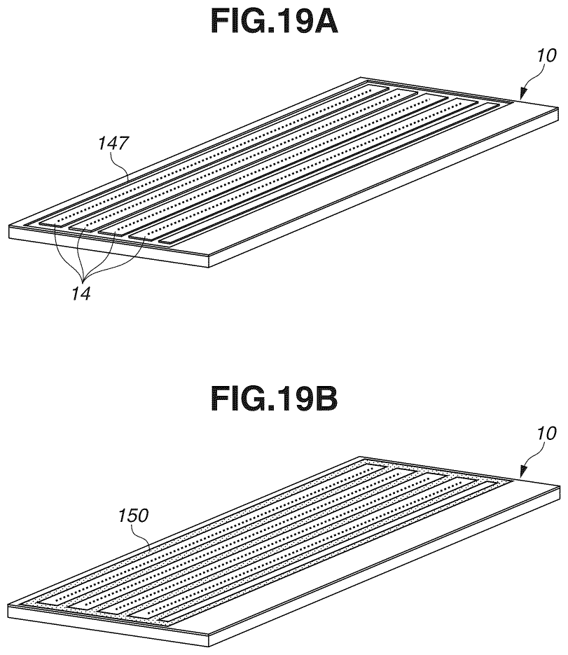

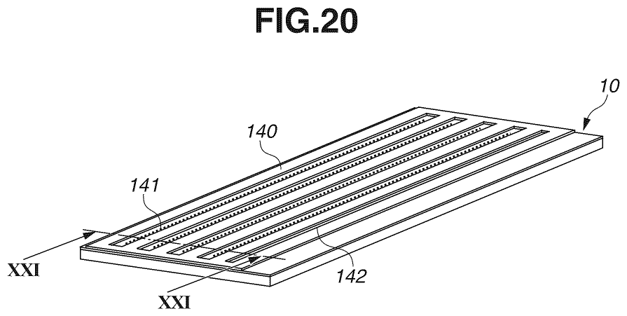

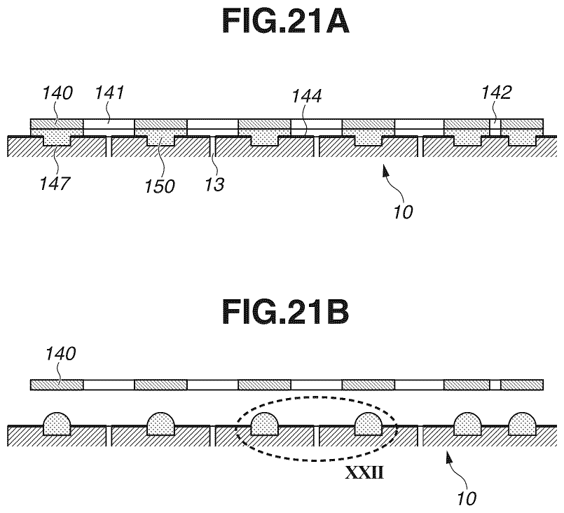

FIGS. 19A and 19B illustrate a device substrate 10 in which the water repellent layer 144 is disposed on the ejection surface 120 and the non-water-repellent region 145 to which the adhesive 150 is applied is formed into a recessed shape to form a recessed portion 147. In FIGS. 19A and 19B, and FIG. 20, which will be described below, a part of the configuration is simplified for easy understanding. FIG. 19A illustrates a state in which a part of the continuous non-water-repellent recessed portion 147 is formed on the outer periphery of each ejection port rows 14, and further, when the protective member 140 is bonded, the other part of the continuous non-water-repellent recessed portion 147 is also disposed on the outer periphery of the external-to-ejection-port-region ports 142. FIG. 19B illustrates a state in which the adhesive 150 is applied to the recessed portion 147. The protective member 140 to be joined is the protective member 140 in FIG. 18. FIGS. 21A and 21B illustrate a process of bonding the protective member 140. FIG. 21A is a cross-sectional view taken along a line XXI-XXI of FIG. 20, and FIG. 21B is a cross-sectional view illustrating a state before the protective member 140 of FIG. 21A is bonded. FIGS. 22A to 22H illustrate a method of forming the recessed portion 147 in the present exemplary embodiment at an XXII portion in FIG. 21B. First, in FIG. 22A, a polyethylene terephthalate (PET) film having a thickness of 100 μm was prepared as a base material 160. Next, as illustrated in FIG. 22B, a material for a first dry film 161 described in Table 1 was applied onto the base material 160 by a spin coating method, and the solvent was volatilized by baking at 90° C. for 20 min, forming a film (the first dry film 161) having a thickness of 8 μm. Next, as illustrated in FIG. 22C, the device substrate 10 was prepared (the supply ports 17a and the collection ports 17b are not illustrated). Next, as illustrated in FIG. 22D, the base material 160 having the first dry film 161 created in FIG. 22B was heated at 80° C. by using a lamination method and transferred while being pressurized, forming a layer of the first dry film 161. Thereafter, the base material 160 was peeled off from the first dry film 161 (not illustrated). Next, as illustrated in FIG. 22E, the first dry film 161 was subjected to pattern exposure with an exposure amount of 16000 J/m² via a flow path forming mask 162 having a flow path pattern, and further subjected to heat treatment at 50° C. for 5 min to cure the exposed portion. Next, as illustrated in FIG. 22F, a second dry film 163 was formed on the first dry film 161. The second dry film 163 was formed by applying a material for the second dry film 163 having components illustrated in Table 1 onto a PET film having a thickness of 100 μm, and then baking the combination at 90° C. for 5 min to volatilize the solvent, forming a film (the second dry film 163) having a thickness of 6 μm. Next, the second dry film 163 was transferred and laminated on the first dry film 161 by a lamination method while applying heat at 50° C., and a laminate was obtained. Next, as illustrated in FIG. 22G, the second dry film 163 was subjected to pattern exposure with an exposure amount of 1100 J/m² via an ejection port forming mask 164 having a pattern of ejection ports 13 and recessed portions 147, and further subjected to heat treatment at 90° C. for 5 min to cure the exposed portion. In FIG. 22H, the uncured portions of the first dry film 161 and the second dry film 163 were developed with propylene glycol methyl ether acetate (PGMEA) for one hour to be collectively removed, forming the ejection port forming member 12. Further, the ejection port forming member 12 was completed by promoting curing by a heat treatment at 200° C.

Since the non-water-repellent region 145 has a recessed shape, the recessed portion 147 serves as a wedge, increasing the bonding force of the protective member 140. In addition, in order to increase the bonding force between the device substrate 10 and the protective member 140, it is desirable to widen the bonding region as much as possible. For that reason, it is desirable to continuously apply the adhesive 150 between the ejection port rows 14 as illustrated in FIGS. 17D to 17F. Further, as illustrated in FIGS. 17E to 17F, the bonding region can be further widened by continuously applying the adhesive to the entire region of the ejection port rows 14. Further, even in a wide region where the ejection port rows 14 are not arranged as illustrated in FIGS. 17D to 17F, the recessed portion 147 that is substantially parallel to the ejection port rows 14 and is continuously connected is formed, and the adhesive 150 is applied, so that an optimal amount of the adhesive 150 can be easily supplied to the bonding region. Further, as illustrated in FIG. 18C, the protective member 140 is bonded such that the external-to-ejection-port-region ports 142 are substantially parallel to the ejection port rows 14, and thus an opening is present in any region where portions of the adhesive 150 spread toward each other, making it possible to further reduce the occurrence rate of the air bubbles 143 being trapped in.

A third exemplary embodiment of the present disclosure will be described. Description of functions and configurations similar to those of the basic configuration described above and the first and second exemplary embodiments will be omitted, and different points will be described.

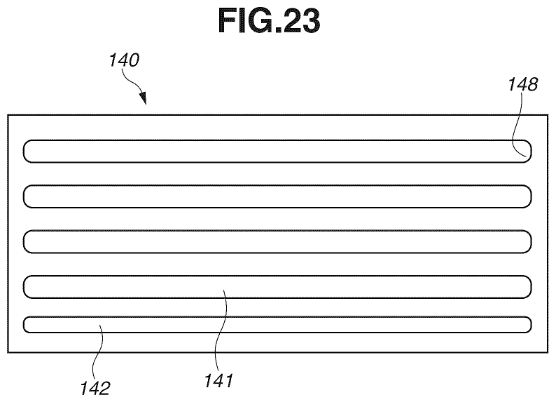

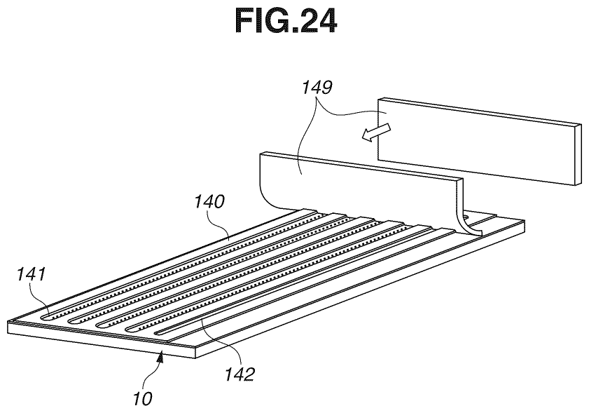

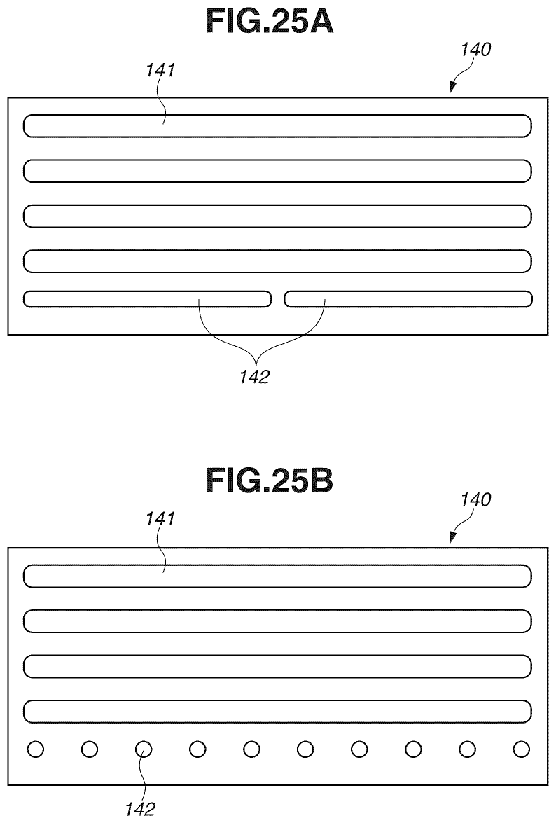

FIG. 23 illustrates a protective member 140 according to the present exemplary embodiment. FIG. 23, and FIG. 24 and FIG. 25A and 25B, will be described below, each illustrate a configuration that is partially simplified for easy understanding. The four corners of each of the openings in the protective member 140 each has a round shape 148. FIG. 24 illustrates a state in which foreign matter or the like is being wiped off the ejection surface 120 with a blade 149 of a cleaning mechanism. In the present exemplary embodiment, cleaning is performed by wiping with the blade 149 in a direction substantially parallel to the direction in which the ejection ports 13 in the ejection port rows 14 are arranged. At this time, if the four corners of each opening of the protective member 140 are acute angles, the rubber blade may be damaged. The round shape 148 of each of the four corners of the openings of the protective member 140 can significantly reduce the possibility of the blade 149 being damaged during cleaning. The present exemplary embodiment uses the device substrate 10 illustrated in FIGS. 19A and 19B. The water repellent layer 144 is disposed on the ejection surface 120, and the non-water-repellent region 145 to which the adhesive 150 is applied is formed as the recessed portion 147. The other conditions of the device substrate 10 are the same as those of the first exemplary embodiment. The protective member 140 is the same as that of the first exemplary embodiment except that the port width of each of the external-to-ejection-port-region ports 142 is 150 μm and the radius of the arc of the round shape 148 is 50 μm. The radius of the arc of the round shape 148 is preferably 5 μm or more, more preferably 10 μm or more, and still more preferably 15 μm or more.

Even in a case of a form where the adhesive application regions are all connected with the recessed portion 147 in the device substrate 10 as illustrated in FIGS. 19A and 19B, some of the external-to-ejection-port-region ports 142 in the protective member 140 may be divided as illustrated in FIGS. 25A and 25B. By dividing the external-to-ejection-port-region ports 142 and making each port smaller, the rigidity of the protective member 140 can be increased, and the handling operation at the time of bonding is improved.

A fourth exemplary embodiment of the present disclosure will be described. Description of functions and configurations similar to those of the basic configuration described above and the first to third exemplary embodiments will be omitted, and different points will be described.

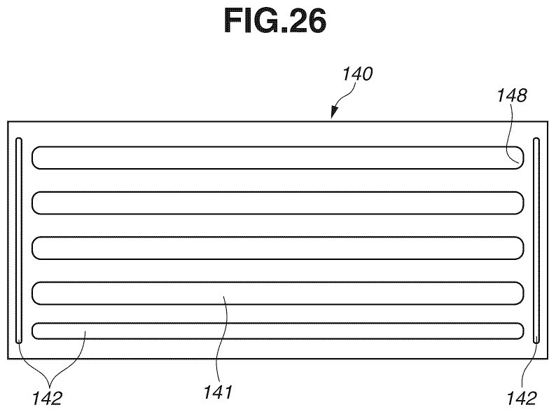

FIG. 26 illustrates a protective member 140 according to the present exemplary embodiment. FIG. 26 illustrates a configuration that is partially simplified for easy understanding. In this exemplary embodiment, the blade 149 of the cleaning mechanism travels in the same direction as in the second exemplary embodiment. The protective member 140 is provided with the external-to-ejection-port-region ports 142 extending in a direction intersecting with the arrangement direction of the ejection ports 13 at sides (end portions) of the ejection port rows 14. This configuration causes the blade 149 to pass through the external-to-ejection-port-region ports 142 before entering the ejection port rows 14. This allows, even if foreign matter or the like is present on the blade 149, the foreign matter is removed when the blade 149 passes through the external-to-ejection-port-region ports 142, allowing the ejection ports 13 to be cleaned with the blade 149 in a clean state.

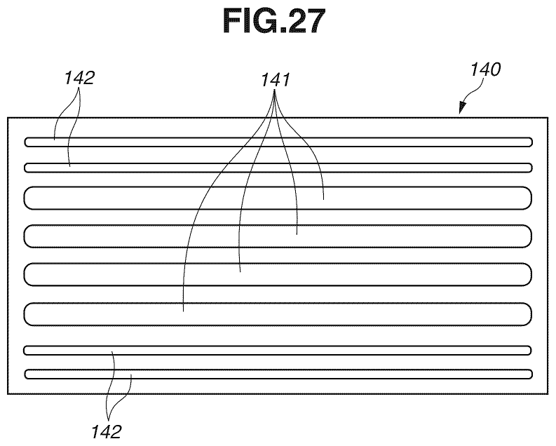

A fifth exemplary embodiment of the present disclosure will be described. FIG. 27 illustrates a protective member 140, which is a modification of the one of FIG. 26, according to the present exemplary embodiment. FIG. 27 illustrates a configuration that is partially simplified for easy understanding. In the present exemplary embodiment, the direction in which the blade 149 of the cleaning mechanism travels is different from that of the fourth exemplary embodiment described above and that of FIG. 24, and cleaning is performed by the blade 149 performing wiping in a direction intersecting the direction in which the ejection ports 13 in the ejection port rows 14 are arranged. Further, two external-to-ejection-port-region ports 142 are arranged on each side of the ejection-port-region openings 141 in a direction intersecting with the direction in which the ejection ports 13 are arranged. The blade 149 of the cleaning mechanism passes through the external-to-ejection-port-region ports 142 before entering the ejection port rows 14. This allows, even if foreign matter or the like is present on the blade 149, the foreign matter is removed when the blade 149 passes through the external-to-ejection-port-region ports 142, allowing the ejection ports 13 to be cleaned with the blade 149 in a clean state.

TABLE 1

| | | | Amount (parts | |
|---|---|---|---|---|
| | | | by weight) | |
| Components | | | First | Second |
| Material | Product name | Manufacturer | film | film |
| Epoxy resin | EPICLON | DIC | 100 | — |
| | N695 | | | |
| | JER1009F | Mitsubishi Chemical | 200 | — |
| | JER157S70 | Mitsubishi Chemical | — | 100 |
| Photoacid | CPI-410S | San-Apro | 3 | 4 |
| generator | SP-172 | ADEKA | 7 | — |
| Acid generator | TPS-1000 | Midori Kagaku | 1 | — |
| Silane coupling | A-187 | Momentive | 10 | 1 |
| agent | | Performance | | |
| | | Materials | | |
| Solvent | PGMEA | — | 566 | 140 |

According to the exemplary embodiments of the present disclosure, even in a configuration in which a protective member is bonded to an ejection surface with an adhesive, a liquid ejection head is provided that reduces the risk of trapping air bubbles in the adhesive, prevents the adhesive from being scattered, and has high reliability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-104684, filed Jun. 28, 2024, which is hereby incorporated by reference herein in its entirety.

What is claimed is:

1. A liquid ejection head comprising:
an ejection substrate including an ejection port row in a first surface, the ejection port row having a plurality of ejection ports configured to eject liquid arranged in the ejection port row; and
a protective member configured to be bonded to the first surface of the ejection substrate via an adhesive, the protective member including a first opening corresponding to the ejection port row,
wherein the protective member further includes a second opening between the first opening and an outer edge of the protective member and outside a region where the ejection ports are formed, when viewed from a direction perpendicular to the first surface.

2. The liquid ejection head according to claim 1, wherein the first surface has a water-repellent region and a non-water-repellent region, and at least part of the adhesive is disposed in the non-water-repellent region.

3. The liquid ejection head according to claim 2, wherein the non-water-repellent region has a recessed shape.

4. The liquid ejection head according to claim 2, wherein the non-water-repellent region surrounds the ejection port row.

5. The liquid ejection head according to claim 2, wherein the non-water-repellent region corresponding to a plurality of the ejection port rows different from each other is arranged continuously connected.

6. The liquid ejection head according to claim 2, wherein at least a part of the non-water-repellent region and at least a part of the second opening are arranged substantially parallel to the ejection port row.

7. The liquid ejection head according to claim 6, wherein the non-water-repellent region corresponding to the first opening and the non-water-repellent region corresponding to the second opening are continuously formed.

8. The liquid ejection head according to claim 1, wherein the second opening has an opening width of at least 5 μm or more, when viewed from a direction perpendicular to the first surface.

9. The liquid ejection head according to claim 1, wherein the second opening has an opening width of at least 10 μm or more, when viewed from a direction perpendicular to the first surface.

10. The liquid ejection head according to claim 1, wherein the second opening has an opening width of at least 15 μm or more, when viewed from a direction perpendicular to the first surface.

11. The liquid ejection head according to claim 1, wherein a ratio of a total area of the first opening and the second opening to an area of the protective member is 70% or less, when viewed from a direction perpendicular to the first surface.

12. The liquid ejection head according to claim 1, wherein the second opening has a round shape when viewed from a direction perpendicular to the first surface.

13. The liquid ejection head according to claim 12, wherein the radius of the round shape is 5 μm or more.

14. The liquid ejection head according to claim 1, wherein the first surface is made of resin.

15. The liquid ejection head according to claim 1, wherein the protective member is made of metal.

16. The liquid ejection head according to claim 1,
wherein the ejection substrate includes an energy generation element for ejecting liquid from the ejection ports, and a terminal row in which a plurality of terminals for supplying a drive signal or electric power to the energy generation element are arranged, and
wherein the protective member includes the second opening between the first opening and the terminal row, when viewed from a direction perpendicular to the first surface.

17. A liquid ejection head comprising:
an ejection substrate including a plurality of ejection port rows in a first surface, the ejection port rows having a plurality of ejection ports configured to eject liquid arranged in the ejection port rows; and
a protective member configured to be bonded to the first surface of the ejection substrate via an adhesive, the protective member including a plurality of first openings corresponding to the ejection port rows,
wherein the protective member further includes a second opening between the first openings adjacent to each other. when viewed from a direction perpendicular to the first surface.
